(19) United States
(12) Patent Application Publication
(10) Pub. No.: US 2021/0182999 A1
(43) Pub. Date: Jun. 17, 2021

(54) CONTROL DEVICE, PROGRAM FOR CONTROL DEVICE, AND PROGRAM FOR TERMINAL DEVICE

(71) Applicant: Toyota Jidosha Kabushiki Kaisha, Toyota-shi Aichi-ken (JP)

(72) Inventor: Daiki Kaneichi, Tokyo (JP)

(73) Assignee: Toyota Jidosha Kabushiki Kaisha, Toyota-shi Aichi-ken (JP)

(21) Appl. No.: 17/108,474

(22) Filed: Dec. 1, 2020

(30) Foreign Application Priority Data
Dec. 11, 2019 (JP) 2019-223856

(51) Int. Cl. G06Q 50/30; H04L 29/08; H04L 12/58; G06Q 10/08; G06Q 30/02; G06Q 10/06; G06Q 50/00; G05D 1/02

(52) U.S. Cl. CPC G06Q 50/30; H04L 67/18; H04L 51/046; G06Q 10/083; G05D 1/0225; G06Q 10/06315; G06Q 10/06312; G06Q 50/01; G06Q 30/0206

(57) ABSTRACT

A control device includes a control unit configured to generate a result of comparison between a travel plan of a transportation vehicle and a travel plan of a delivery vehicle. The transportation vehicle is a vehicle that transports a user from a user position where the user is positioned to a facility location where a facility is located. The delivery vehicle is a vehicle that delivers goods provided at the facility from the facility location to the user position.

### CROSS-REFERENCE TO RELATED APPLICATION

This application claims priority to Japanese Patent Application No. 2019-223856 filed on Dec. 11, 2019, incorporated herein by reference in its entirety.

### BACKGROUND

### 1. Technical Field

The present disclosure relates to a control device, a program for the control device, and a program for a terminal device.

### 2. Description of Related Art

Conventionally, a technique for dispatching a vehicle is known. For example, Japanese Unexamined Patent Application Publication No. 2002-342426 (JP 2002-342426 A) describes a technique for dispatching a vehicle based on vehicle dispatch request information sent from a portable device via a communication means.

### SUMMARY

In recent years, further improvement in the convenience of the technique for dispatching a vehicle is desired.

The present disclosure provides a control device, a program for the control device, and a program for a terminal device that improve the convenience of a technique for dispatching a vehicle.

A first aspect of the present disclosure relates to a control device including a control unit. The control unit is configured to generate a result of comparison between a travel plan of a transportation vehicle and a travel plan of a delivery vehicle. The transportation vehicle is a vehicle that transports a user from a user position where the user is positioned to a facility location where a facility is located. The delivery vehicle is a vehicle that delivers goods provided at the facility from the facility location to the user position.

A second aspect of the present disclosure relates to a program that causes an information processing device to function as a control device including a control unit. The control unit is configured to generate a result of comparison between a travel plan of a transportation vehicle and a travel plan of a delivery vehicle. The transportation vehicle is a vehicle that transports a user from a user position where the user is positioned to a facility location where a facility is located. The delivery vehicle is a vehicle that delivers goods provided at the facility from the facility location to the user position.

A third aspect of the present disclosure relates to a program that causes an information processing device to function as a terminal device including a control unit. The control unit is configured to control a display of a result of comparison between a travel plan of a transportation vehicle and a travel plan of a delivery vehicle. The transportation vehicle is a vehicle that transports a user from a user position where the user is positioned to a facility location where a facility is located. The delivery vehicle is a vehicle that delivers goods provided at the facility from the facility location to the user position.

The control device, the program for the control device, and the program for the terminal device according to the first aspect, second aspect, and third aspect of the present disclosure improve the convenience of the technique for dispatching a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system according to one embodiment;

FIG. 2 is a block diagram showing a schematic configuration of a vehicle according to one embodiment;

FIG. 3 is a block diagram showing a schematic configuration of a terminal device according to one embodiment;

FIG. 4 is a block diagram showing a schematic configuration of a control device according to one embodiment;

FIG. 5 is a diagram showing an example of an operation of the information processing system according to one embodiment;

FIG. 6 is a diagram showing an example of an operation of the information processing system according to one embodiment;

FIG. 7 is a diagram showing an example of an operation of the information processing system according to one embodiment; and

FIG. 8 is a diagram showing an example of a screen displayed on the terminal device according to one embodiment.

### DETAILED DESCRIPTION OF EMBODIMENTS

One embodiment of the present disclosure will be described below with reference to the drawings.

In the figures, the same reference numerals will be given to the same or similar components. In the description of this embodiment, the description of the same or similar components will be omitted or simplified as appropriate.

### Configuration of Information Processing System

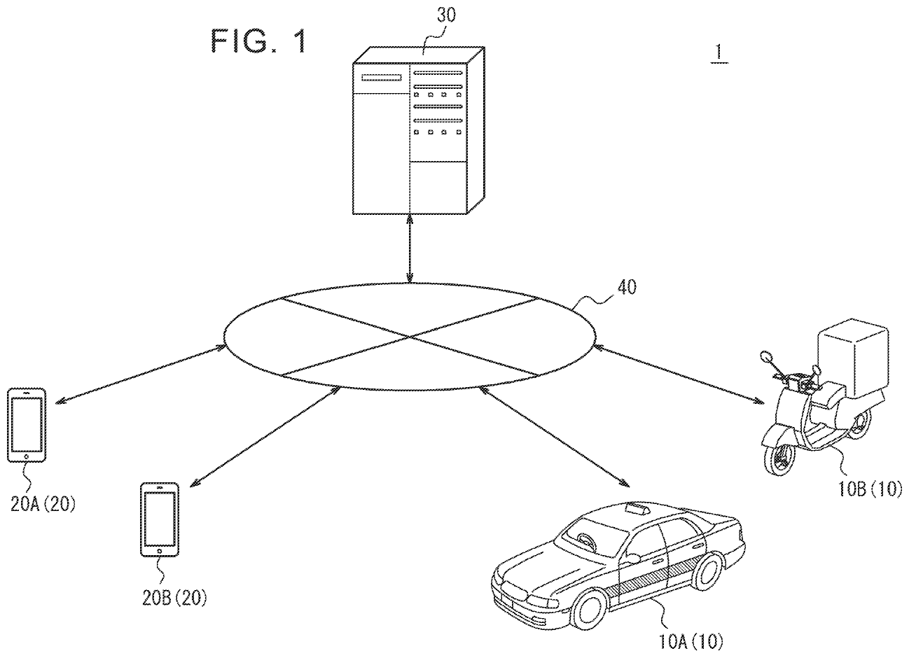

An outline of a configuration of an information processing system 1 according to this embodiment will be described with reference to FIG. 1. The information processing system 1 includes vehicles 10, terminal devices 20, and a control device 30. In this embodiment, the terminal devices 20 corresponds to clients, and the control device 30 correspond to a server, in a client server system. In FIG. 1, two vehicles 10 and two terminal devices 20 and one control device 30 are shown for the sake of simplicity. However, the information processing system 1 may include any number of vehicles 10, terminal devices 20, and control devices 30.

The vehicle 10 is any vehicle that carries at least one of users and goods, such as an on-demand bus, rental car, shared car, taxi, bike, truck, and motorcycle. The vehicle 10 includes a transportation vehicle 10A for transporting users and a delivery vehicle 10B for delivering goods. In this embodiment, it is assumed that the transportation vehicle 10A is a taxi and the delivery vehicle 10B is a motorcycle. However, the transportation vehicle 10A and the delivery vehicle 10B may be any vehicles. The transportation vehicle 10A and the delivery vehicle 10B may be the same vehicle or different vehicles. In the description below, when it is not necessary to distinguish the transportation vehicle 10A and delivery vehicle 10B, these vehicles will be simply referred to as the vehicle 10. The vehicle 10 may be driven by a driver or may be driven autonomously at any level. The autonomous driving level is, for example, any of level 1 to level 5 defined by Society of Automotive Engineers (SAE).

The terminal device 20 is an information processing device such as a mobile phone, a smart phone, and a personal computer. In this specification, the information processing device is also referred to as a computer. In this embodiment, the terminal device 20 includes a terminal device 20A carried by user U1 and a terminal device 20B carried by user U2. In the description below, when it is not necessary to distinguish the terminal devices 20A and 20B, these terminal devices will be simply referred to as the terminal device 20.

The control device 30 includes one information processing device or a plurality of information processing devices that can communicate with each other. In this embodiment, the control device 30 provides the social networking service (SNS) and, at the same time, provides the vehicle dispatch service in which the vehicle 10 is dispatched. In this embodiment, an example of the SNS is assumed to be a service that provides users with the chat function for sending and receiving instant messages among a plurality of users. However, the SNS may include services such as websites and blogs via which information is shared in any form.

Each of the vehicles 10, the terminal devices 20, and the control device 30 can communicate with each other via the network 40. The network 40 is any communication network over which the vehicles 10, the terminal devices 20, and the control device 30 can communicate with each other. The network 40 may be a wireless or wired transmission path and may be a communication network such as the Internet. For example, the network 40 in this embodiment may include the following types of network: an ad hoc network, a metropolitan area network (MAN), a cellular network, a wireless personal area network (WPAN), a public switched telephone network (PSTN), or a terrestrial wireless network, an optical networks, or other networks, or any combination thereof.

The information processing system 1 provides the vehicle dispatch service in such a way that the information about the dispatch of the vehicles 10 is provided to the users of the dispatch service.

The control device 30 provides, for example, the chat function that allows a plurality of users to send and receive instant messages among them. The control device 30 identifies the user position, where the user is positioned, and the facility location, where the facility is located, based on one or more instant messages sent and received in a chat. The control device 30 compares the travel plan of the transportation vehicle 10A that transports users from the user positions to the facility position and the travel plan of the delivery vehicle 10B that delivers goods, provided at the facility, from the facility position to the user positions and generates the result of comparison. In this embodiment, it is assumed that the facility is a restaurant and that the goods, provided at the facility, are food. However, the facility and the goods, provided by the facility, may be freely determined.

The terminal device 20 communicates with the control device 30 and displays instant messages sent and received among a plurality of users. In addition, the terminal device 20 receives and displays the generated result of comparison received from the control device 30. This allows the user of the terminal device 20 to refer to the displayed result of comparison to select a dispatch of one of the two vehicles, either transportation vehicle 10A or the delivery vehicle 10B, improving the convenience of technique for dispatching the vehicle 10. In this embodiment, the “travel plan” of the vehicle 10 is the travel schedule of the vehicle 10. For example, the travel plan of the vehicle 10 includes the following: information on the start point and the destination of the vehicle 10, the traveling route of the vehicle 10, the scheduled start time from the start point, the estimated arrival time at the destination, the number of passengers, and the cost of traveling of the vehicle 10.

Next, the vehicle 10, the terminal device 20, and the control device 30 included in the information processing system 1 will be described in detail.

### Configuration of Vehicle

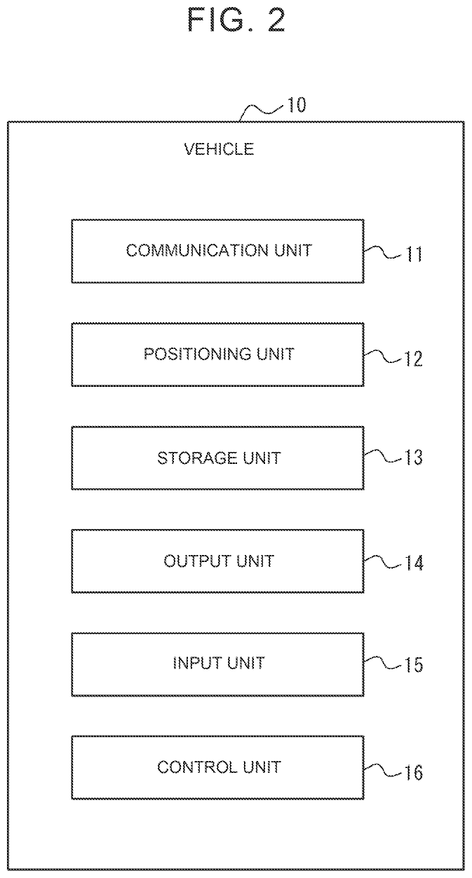

A configuration of the vehicle 10 according to this embodiment will be described with reference to FIG. 2. As shown in the block diagram in FIG. 2, the vehicle 10 includes a communication unit 11, a positioning unit 12, a storage unit 13, an output unit 14, an input unit 15, and a control unit 16. The communication unit 11, positioning unit 12, storage unit 13, output unit 14, input unit 15, and control unit 16 may each be incorporated in the vehicle 10, or may be removably provided in the vehicle 10. When removably provided in the vehicle 10, each of the communication unit 11, positioning unit 12, storage unit 13, output unit 14, input unit 15, and control unit 16 may be provided in a removable information processing device, such as a car navigation device, in the vehicle 10. The communication unit 11, positioning unit 12, storage unit 13, output unit 14, input unit 15, and control unit 16 communicate with each other by wire or wirelessly through an in-vehicle network such as a controller area network (CAN) or through a dedicated line.

The communication unit 11 includes a communication module for connection to the network 40. The communication module is a communication module compatible with the fourth generation (4G) or fifth generation (5G) mobile communication standard. For example, an in-vehicle communication device may function as the communication unit 11. In this embodiment, the vehicle 10 is connected to the network 40 via the communication unit 11. This allows the vehicle 10 to communicate with the control device 30 and the like.

The positioning unit 12 measures the position of the vehicle 10 and generates the position information. In this embodiment, “position information” is the information that can identify a position. In this embodiment, the position information includes coordinates such as two-dimensional coordinates or three-dimensional coordinates. However, the position information is not limited to the coordinates and may include a speed, a moving route, a moving distance, or a change amount and a change rate thereof. The positioning unit 12 includes a receiver compatible with a satellite positioning system. The satellite positioning system supported by the receiver may be, for example, Global Positioning System (GPS). For example, a car navigation device may function as the positioning unit 12.

The storage unit 13 is a semiconductor memory, a magnetic memory, an optical memory, or the like. The storage unit 13 functions, for example, as a main storage device, an auxiliary storage device, or a cache memory. The storage unit 13 stores any information used for the operation of the vehicle 10. For example, the storage unit 13 stores system programs, application programs, and embedded software. The information stored in the storage unit 13 may be updatable with the information acquired from the network 40, for example, via the communication unit 11.

The output unit 14 outputs the information in the form of an image, text, sound, and the like. The output unit 14 includes an output device such as a display and a speaker. For example, a car navigation device may function as the output unit 14. The output unit 14 displays the information such as a travel route, for example, included in the travel plan of the vehicle 10, on the display.

The input unit 15 receives an input operation. The input unit 15 includes input devices such as a touch panel, physical keys, a camera, a microphone, and an IC card reader. For example, a car navigation device may function as the input unit 15.

The control unit 16 includes one or more processors. The processor may be a general-purpose processor such as a central processing unit (CPU), or a dedicated processor specialized for specific processing. The control unit 16 is not limited to a processor and may include one or more dedicated circuits. The dedicated circuit may be, for example, a field-programmable gate array (FPGA) or an application specific integrated circuit (ASIC). The control unit 16 controls each of the communication unit 11, the positioning unit 12, the storage unit 13, the output unit 14, and the input unit 15 described above for implementing the functions of those units.

### Configuration of Terminal Device

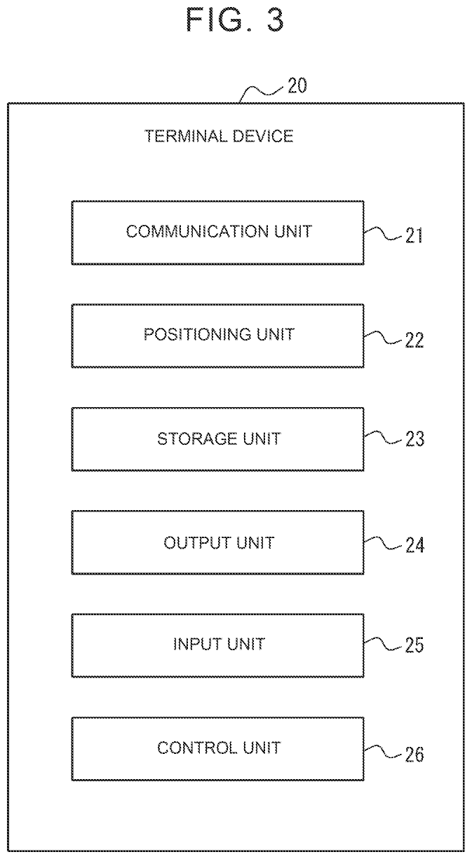

A configuration of the terminal device 20 according to this embodiment will be described with reference to FIG. 3. As shown in the block diagram shown in FIG. 3, the terminal device 20 includes a communication unit 21, a positioning unit 22, a storage unit 23, an output unit 24, an input unit 25, and a control unit 26. The communication unit 21, the positioning unit 22, the storage unit 23, the output unit 24, the input unit 25, and the control unit 26 are communicably connected to each other by wire or wirelessly.

The communication unit 21 includes a communication module for connection to the network 40. The communication module may be a communication module compatible with the 4G or 5G mobile communication standard. In this embodiment, the terminal device 20 is connected to the network 40 via the communication unit 21. This allows the terminal device 20 to communicate with the control device 30 and the like.

The positioning unit 22 measures the position of the terminal device 20 and generates the position information. The positioning unit 22 includes a receiver compatible with a satellite positioning system. The satellite positioning system supported by the receiver may be the GPS.

The storage unit 23 is, for example, a semiconductor memory, a magnetic memory, and an optical memory. The storage unit 23 may function, for example, as a main storage device, an auxiliary storage device, or a cache memory. The storage unit 23 stores any information used for the operation of the terminal device 20. For example, the storage unit 23 stores system programs, application programs, and embedded software. The information stored in the storage unit 23 may be updatable with the information acquired from the network 40, for example, via the communication unit 21.

The output unit 24 outputs the information in the form of an image, text, sound, and the like. The output unit 24 includes an output device such as a display and a speaker. The output unit 24 displays one or more instant messages, sent and received in a chat among a plurality of users, for example, on the display.

The input unit 25 receives an input operation. The input unit 25 includes input devices such as a touch panel, physical keys, a camera, a microphone, and an IC card reader. For example, the input unit 25 receives an input operation to enter text that is sent as an instant message.

The control unit 26 includes one or more processors. The processor may be a general-purpose processor, such as a CPU, or a dedicated processor specialized for specific processing. The control unit 26 is not limited to a processor and may include one or more dedicated circuits. The dedicated circuit may be, for example, an FPGA or an ASIC. The control unit 26 controls each of the communication unit 21, positioning unit 22, storage unit 23, output unit 24, and input unit 25 described above for implementing the functions of those units.

The function of the terminal device 20 is implemented when the processor of a computer, which is an information processing device, executes the program in this embodiment. That is, the function of the terminal device 20 is implemented by software.

The program causes the computer to perform the processing of the steps included in the operation of the terminal device 20 so that the computer can implement the function corresponding to the processing of the steps. That is, the program causes the computer to function as the terminal device 20.

The program can be recorded in a computer-readable recording medium. The computer-readable recording medium is, for example, a magnetic recording device, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) in which the program is recorded. Furthermore, the program may be distributed by storing it in the storage of a predetermined server and by transferring the program from the predetermined server to another computer. In addition, the program may be provided as a program product.

The computer once stores in the memory the program recorded in the portable recording medium or the program transferred from the predetermined server. After that, the computer reads the program from the memory through the processor and performs processing on the processor according to the program that has been read. The computer may also read the program directly from the portable recording medium and perform processing according to the program. In addition, the computer may perform processing according to the received program each time the program is transferred from the predetermined server to the computer. Furthermore, the computer may perform processing by the so-called application service provider (ASP) service. In this case, the program is not transferred from the predetermined server to the computer; instead, the function is implemented only by issuing an execution instruction and then acquiring the result. The program includes program-like information that is used in the processing by the computer. The “program-like information” is, for example, data that is not a command directly sent to a computer but is used to specify computer processing.

### Configuration of Control Device

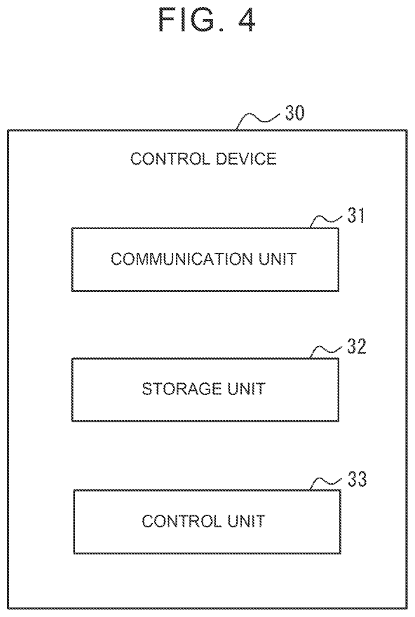

A configuration of the control device 30 according to this embodiment will be described with reference to FIG. 4. As shown in the block diagram of FIG. 4, the control device 30 includes a communication unit 31, a storage unit 32, and a control unit 33. The communication unit 31, storage unit 32, and control unit 33 are connected by wire or wirelessly so that they can communicate with each other.

The communication unit 31 includes a communication module for connection to the network 40. The communication module may be a communication module compatible, for example, with a wired local area network (LAN) standard or a wireless LAN standard. In this embodiment, the control device 30 is connected to the network 40 via the communication unit 31. This allows the control device 30 to communicate with the vehicle 10 and the terminal device 20.

The storage unit 32 is, for example, a semiconductor memory, a magnetic memory, or an optical memory. The storage unit 32 may function, for example, as a main storage device, an auxiliary storage device, or a cache memory. The storage unit 32 stores any information used for the operation of the control device 30. For example, the storage unit 32 stores system programs, application programs, and databases. The information stored in the storage unit 32 may be updatable with the information acquired from the network 40, for example, via the communication unit 31.

The control unit 33 includes one or more processors. The processor may be a general-purpose processor, such as a CPU, or a dedicated processor specialized for specific processing. The control unit 33 is not limited to a processor and may include one or more dedicated circuits. The dedicated circuit may be, for example, an FPGA or an ASIC. The control unit 33 controls each of the communication unit 31 and the storage unit 32 for implementing the functions of those units described above.

The function of the control device 30 is implemented when the processor of a computer, which is an information processing device, executes a program in this embodiment. That is, the function of the control device 30 is implemented by software. The program causes the computer to perform the processing of the steps included in the operation of the control device 30 so that the computer can implement the function corresponding to the processing of the steps. That is, the program causes the computer to function as the control device 30.

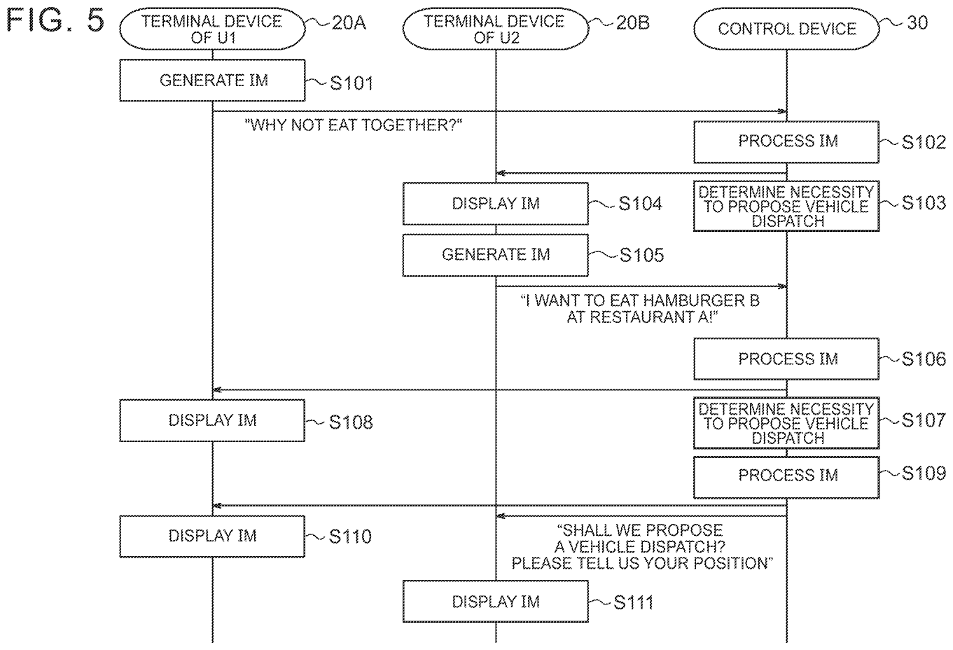

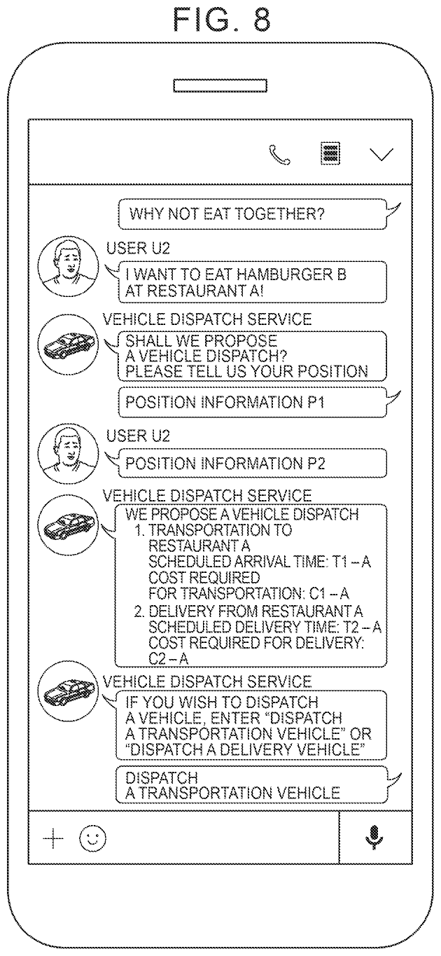

The operation of the information processing system 1 in this embodiment will be described with reference to FIGS. 5, 6, 7 and 8. It is assumed in one example below that user U1 and user U2 have a chat on SNS by sending and receiving instant messages with each other. This operation corresponds to the information processing method according to this embodiment. In FIGS. 5, 6 and 7, an instant message is denoted as “IM”. FIG. 8 shows an example of the screen displayed on the terminal device 20A of user U1.

As shown in FIG. 5, the control unit 26 of the terminal device 20A of user U1 generates an instant message in step S101. More specifically, the control unit 26 receives an operation of user U1 who enters, via the input unit 25, a text addressed to user U2. The control unit 26 generates an instant message that includes the entered text. The control unit 26 sends the generated instant message to the control device 30 via the communication unit 21.

In this example, user U1 enters the text “Why not eat together?” into the terminal device 20A. The control unit 26 of the terminal device 20A sends an instant message including the entered text to the control device 30.

In step S102, the control unit 33 of the control device 30 processes the received instant message. More specifically, the control unit 33 receives the instant message, sent in step S101, via the communication unit 31. The control unit 33 stores the received instant message in the storage unit 32 as one or more instant messages sent and received by user U1. The control unit 33 sends the received instant message to the terminal device 20B of user U2 via the communication unit 31. An instant message may be sent as in a conventional chat on SNS.

In this example, the control unit 33 of the control device 30 sends the instant message, which includes the text “Why not eat together?” received from the terminal device 20A of user U1, to the terminal device 20B of user U2. The control unit 33 stores the instant message, which includes the text “Why not eat together?”, in the storage unit 32 as one or more instant messages sent and received by user U1.

In step S103, the control unit 33 of the control device 30 determines the necessity to propose the dispatch of the vehicle 10 based on one or more instant messages sent and received by user U1. More specifically, the control unit 33 determines, through natural language processing, whether at least one of the information indicating a facility and the information indicating goods provided at a facility is included in the one or more instant messages sent and received by user U1. When the control unit 33 determines that at least one of the information indicating a facility and the information indicating goods provided at a facility is included in the one or more instant messages sent and received by user U1, the control unit 33 identifies the facility location based on this information. For example, when the control unit 33 determines that the information indicating a facility is included in the one or more instant messages sent and received by user U1, the control unit 33 identifies the facility based on the information indicating the facility and identifies the facility location. On the other hand, when the control unit 33 determines that the information indicating goods provided at a facility is included in the one or more instant messages sent and received by user U1, the control unit 33 identifies the facility based on the information indicating goods provided at the facility and identifies the facility location. When the facility location is identified based on the one or more instant messages sent and received by user U1, the control unit 33 stores the identified facility information in the storage unit 32 and determines that it is necessary to propose the dispatch of the vehicle 10.

In this example, the control unit 33 of the control device 30 analyzes the text “Why not eat together?” included in the instant message received from the terminal device 20A of user U1. The control unit 33 determines, through natural language processing, that the text “Why not eat together?” does not include the information indicating a facility. Similarly, the control unit 33 determines, through natural language processing, that the text “Why not eat together?” does not include the information indicating goods provided at a facility. As a result, the control unit 33 determines that the text “Why not eat together?” does not include the information indicating a facility or the information indicating goods provided at a facility and, therefore, determines that it is not necessary to propose the dispatch of the vehicle 10.

In step S104, the control unit 26 of the terminal device 20B of user U2 displays the received instant message. More specifically, the control unit 26 receives the instant message, sent in step S102, via the communication unit 21. The control unit 26 displays the received instant message via the output unit 24.

In this example, the control unit 26 of the terminal device 20B of user U2 receives the instant message including the text “Why not eat together?” from the control device 30. The control unit 26 displays the received instant message, for example, on the display included in the output unit 24.

In step S105, the control unit 26 of the terminal device 20B of user U2 generates an instant message. More specifically, via the input unit 25, the control unit 26 receives an operation by user U2 to enter a text addressed to user U1. The control unit 26 generates an instant message including the entered text. The control unit 26 sends the generated instant message to the control device 30 via the communication unit 21.

In this example, user U2 enters the text “I want to eat hamburger B at restaurant A!” into the terminal device 20B. The control unit 26 of the terminal device 20B sends the instant message including the entered text to the control device 30.

In step S106, the control unit 33 of the control device 30 processes the received instant message as described above in step S102. More specifically, the control unit 33 receives the instant message, sent in step S105, via the communication unit 31. The control unit 33 stores the received instant message in the storage unit 32 as one or more instant messages sent and received by user U2. The control unit 33 sends the received instant message to the terminal device 20A of user U1 via the communication unit 31. The instant message may be sent as in a conventional chat on SNS.

In this example, the control unit 33 of the control device 30 sends the instant message including the text “I want to eat hamburger B at restaurant A!”, received from the terminal device 20B of user U2, to the terminal device 20A of user U1. The control unit 33 stores the instant message, which includes the text “I want to eat hamburger B at restaurant A!”, in the storage unit 32 as one or more instant messages sent and received by user U1.

In step S107, the control unit 33 of the control device 30 determines the necessity to propose the dispatch of the vehicle 10 based on the one or more instant messages sent and received by user U1 as described above in step S103.

In this example, the control unit 33 of the control device 30 analyzes the text “I want to eat hamburger B at restaurant A!” included in the instant message received from the terminal device 20B of user U2. The control unit 33 extracts, through natural language processing, the word “restaurant A” as the information indicating a facility. In addition, the control unit 33 extracts, through natural language processing, the word “hamburger B” as the information indicating the goods provided at the facility (in this case, a food served at the restaurant). Using the extracted words “restaurant A” and “hamburger B” as the keyword, the control unit 33 searches the database or the Internet to identify the facility location where “restaurant A” is located and “hamburger B” is served. The control unit 33 stores the facility location, identified based on “restaurant A” and “hamburger B”, in the storage unit 32 and determines that it is necessary to propose the dispatch of the vehicle 10.

In this example, though the information “restaurant A” indicating a facility and the information “hamburger B” indicating goods provided at the facility are both included in the instant message, the instant message does not need to include one of them. In such a case, the control unit 33 of the control device 30 identifies the facility location where the facility is located based on the information indicating the facility included in the instant message or based on the information indicating the goods provided at the facility included in the instant message.

In step S108, the control unit 26 of the terminal device 20A of user U1 displays the received instant message. More specifically, the control unit 26 receives the instant message, sent in step S106, via the communication unit 21. The control unit 26 displays the received instant message via the output unit 24.

In this example, the control unit 26 of the terminal device 20A of user U1 receives the instant message including the text “I want to eat hamburger B at restaurant A!” from the control device 30. The control unit 26 displays the received instant message, for example, on the display included in the output unit 24.

When the control unit 33 of the control device 30 determines in step S107 that it is necessary to propose the dispatch of the vehicle 10, the control unit 33 of the control device 30 generates, in step S109, an instant message for acquiring the position information on user U1 and user U2. The control unit 33 sends the generated instant message to each of the terminal device 20A of user U1 and the terminal device 20B of user U2 via the communication unit 31.

In this example, the control unit 33 of the control device 30 sends an instant message including the text “Shall we propose a vehicle dispatch? Please tell us your position” to both the terminal device 20A of user U1 and the terminal device 20B of user U2.

In step S110, the control unit 26 of the terminal device 20A of user U1 receives the instant message, sent in step S109, via the communication unit 21. The control unit 26 displays the received instant message via the output unit 24.

In this example, the control unit 26 of the terminal device 20A receives the instant message including the text “Shall we propose a vehicle dispatch? Please tell us your position” from the control device 30. The control unit 26 displays the received instant message, for example, on the display included in the output unit 24.

In step S111, the control unit 26 of the terminal device 20B of user U2 receives the instant message, sent in step S109, via the communication unit 21. The control unit 26 displays the received instant message via the output unit 24.

In this example, the control unit 26 of the terminal device 20B receives the instant message including the text “Shall we propose a vehicle dispatch? Please tell us your position” from the control device 30. The control unit 26 displays the received instant message, for example, on the display included in the output unit 24.

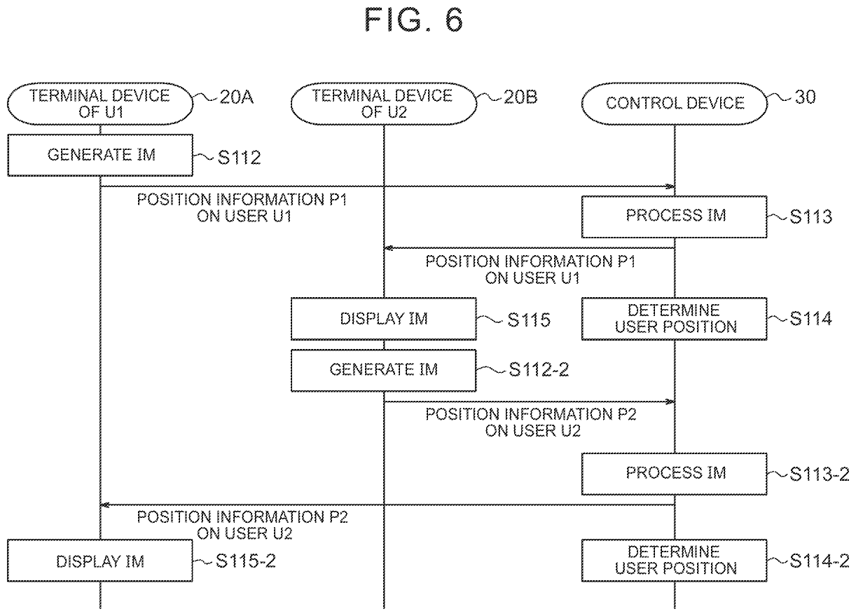

In step S112, the control unit 26 of the terminal device 20A of user U1 generates an instant message including the position information P1 on user U1 as shown in FIG. 6. More specifically, the control unit 26 measures the position of the terminal device 20A itself by the positioning unit 22 and generates the coordinate values of the two-dimensional coordinates or three-dimensional coordinates. The control unit 26 generates an instant message that includes the generated coordinate values as the position information P1 on user U1. The control unit 26 may receive an operation of entering text, such as the address indicating the position of user U1, via the input unit 25. In such a case, the control unit 26 generates an instant message that includes the text of the entered address as the position information P1 on user U1. The control unit 26 sends the generated instant message to the control device 30 via the communication unit 21.

In this example, the control unit 26 of the terminal device 20A sends an instant message to the control device 30. This instant message includes the coordinate values that indicates the position of the terminal device 20A, generated by the positioning unit 22, as the position information P1 on user U1.

In step S113, the control unit 33 of the control device 30 processes the received instant message. More specifically, the control unit 33 receives the instant message, sent in step S112, via the communication unit 31. The control unit 33 stores the received instant message in the storage unit 32 as one or more instant messages sent and received by the user. The control unit 33 sends the received instant message to the terminal device 20B of user U2 via the communication unit 31.

In this example, the control unit 33 of the control device 30 sends and instant message to the terminal device 20B of user U2. This instant message includes the position information P1 on user U1 received from the terminal device 20A of user U1. The control unit 33 stores the instant message, which includes the position information P1 on user U1, in the storage unit 32 as one or more instant messages sent and received by user U1.

In step S114, the control unit 33 of the control device 30 identifies the user position where user U1 is positioned, based on the one or more instant messages sent and received by user U1. More specifically, the control unit 33 determines whether the position information on user U1 is included in the one or more instant messages sent and received by user U1. When the control unit 33 determines that the position information on user U1 is included in the one or more instant messages sent and received by user U1, the control unit 33 identifies the position information, where user U1 is positioned, based on the position information on user U1. The control unit 33 stores the user position in the storage unit 32.

In this example, the control unit 33 of the control device 30 determines whether the position information P1 on user U1 is included in the instant message received from the terminal device 20A of user U1. The control unit 33 stores the coordinate values, which are included in the received instant message as the position information P1 on user U1 and indicate the position of the terminal device 20A, in the storage unit 32 as the user position.

In step S115, the control unit 26 of the terminal device 20B of user U2 displays the received instant message. More specifically, the control unit 26 receives the instant message, sent in step S113, via the communication unit 21. Then, the control unit 26 displays the received instant message via the output unit 24.

In this example, the control unit 26 of the terminal device 20B of user U2 receives the instant message, which includes the position information P1 on user U1, from the control device 30. The control unit 26 displays the received instant message, for example, on the display included in the output unit 24.

The control unit 33 of the control device 30 acquires the position information P2 on user U2 through the processing in step S112-2 to step S115-2 in the same way the control unit 33 of the control device 30 acquires the position information P1 on user U1 through the processing in step S112 to step S115. The processing in step S112-2 to step S115-2 correspond to the processing in step S112 to step S115, respectively.

More specifically, in step S112-2, the control unit 26 of the terminal device 20B of user U2 sends an instant message to the control device 30. This instant message includes the coordinate values that indicates the position of the terminal device 20B, generated by the positioning unit 22, as the position information P2 on user U2.

In step S113-2, the control unit 33 of the control device 30 sends an instant message to the terminal device 20A of user U1. This instant message includes the position information P2 on user U2 received from the terminal device 20B of user U2. The control unit 33 stores the instant message, which includes the position information P2 on user U2, in the storage unit 32 as one or more instant messages sent and received by user U1.

In step S114-2, the control unit 33 of the control device 30 determines whether the position information P2 on user U2 is included in the instant message received from the terminal device 20B of user U2. The control unit 33 stores the coordinate values, which are included in the received instant message as the position information P2 on user U2 and indicate the position of the terminal device 20B, in the storage unit 32 as the user position.

In step S115-2, the control unit 26 of the terminal device 20A of user U1 receives the instant message, which includes the position information P2 on user U2, from the control device 30. The control unit 26 displays the received instant message, for example, on the display included in the output unit 24.

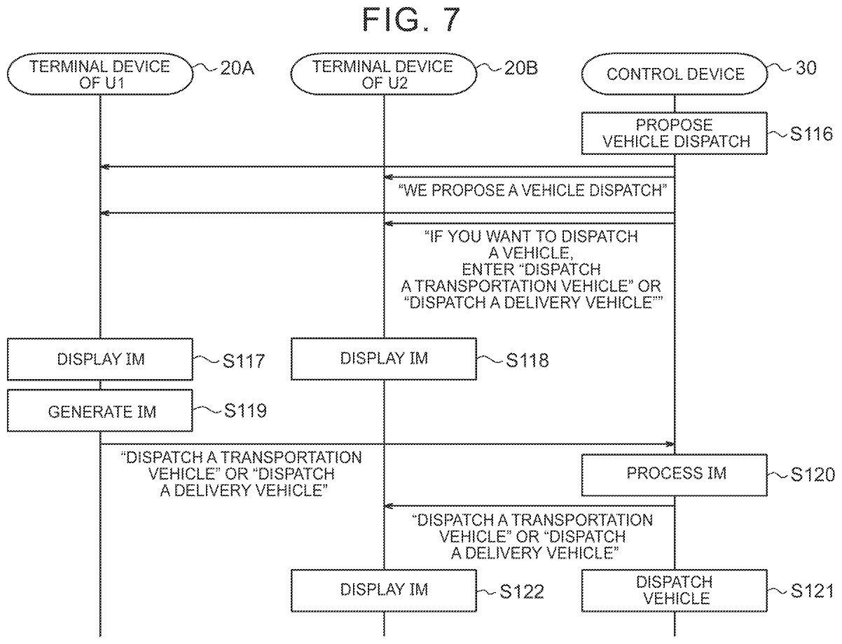

As shown in FIG. 7, when the control unit 33 of the control device 30 determines in step S114 or in step S114-2 that the position information on user U1 or user U2 is included in the instant message, the control unit 33 of the control device 30 proposes a dispatch of the vehicle 10 in step S116.

In step S116, the control unit 33 generates a result of comparison between the travel plan of the transportation vehicle 10A that transports the user from the user position where the user is positioned to the facility location where the facility is located and the travel plan of the delivery vehicle 10B that delivers goods provided at the facility from the facility location to the user position. Although, in this example, the control unit 33 identifies the user positions of user U1 and user U2 who send and receive instant messages, the control unit 33 may identify only one of the users. When the position of only one user is identified, the control unit 33 performs the processing of this step for the position of only one user.

More specifically, the control unit 33 of the control device 30 acquires the information on the dispatchable transportation vehicles 10A. In this embodiment, it is assumed that the control unit 33 stores the information on the dispatchable transportation vehicles 10A in the storage unit 32 in advance. When there is a plurality of dispatchable transportation vehicles 10A, the control unit 33 acquires the information on the transportation vehicle 10A closest to the user position where the user is positioned. The information on the transportation vehicle 10A includes, for example, the vehicle type, vehicle registration number, and position of the transportation vehicle 10A. The control unit 33 generates the travel plan of the transportation vehicle 10A, which transports the user from the user position to the facility location, based on the acquired position of the transportation vehicle 10A, the user position, and the facility location. The control unit 33 calculates first time T1, which is the time when the transportation vehicle 10A arrives at the facility location, and first cost C1, which is the cost required for transportation by the transportation vehicle 10A, based on the generated travel plan of the transportation vehicle 10A.

In addition, the control unit 33 of the control device 30 acquires the information on the dispatchable delivery vehicles 10B. In this embodiment, it is assumed that the control unit 33 stores the information on the dispatchable delivery vehicles 10B in the storage unit 32 in advance. When there is a plurality of dispatchable delivery vehicles 10B, the control unit 33 acquires the information on the delivery vehicle 10B that is closest to the facility location where the facility is located. The information on the delivery vehicle 10B includes, for example, the vehicle type, vehicle registration number, and position of the delivery vehicle 10B. The control unit 33 generates the travel plan of the delivery vehicle 10B, which delivers the goods provided at the facility from the facility location to the user positions, based on the acquired position of the delivery vehicle 10B, the user position, and the facility location. The control unit 33 calculates second time T2, which is the time when the delivery vehicle 10B arrives at the user position, and second cost C2, which is the cost required for delivery by the delivery vehicle 10B, based on the generated travel plan of the delivery vehicle 10B.

The control unit 33 of the control device 30 generates a result of comparison between the travel plan of the transportation vehicle 10A and the travel plan of the delivery vehicle 10B. The result of comparison may include the result of comparison between first time T1 and second time T2 described above. The result of comparison may include the result of comparison between first cost C1 and second cost C2 described above. The control unit 33 generates an instant message that includes the result of comparison between the travel plan of the transportation vehicle 10A and the travel plan of the delivery vehicle 10B. The control unit 33 sends the instant message, which includes the generated result of comparison, to the terminal device 20A of user U1 and the terminal device 20B of user U2 via the communication unit 31.

In addition, the control unit 33 of the control device 30 generates not only the instant message that includes the result of comparison but also an instant message that prompts the user to return a response indicating whether the user wants to dispatch the vehicle 10. The control unit 33 sends the instant message, which includes the generated result of comparison, to the terminal device 20A of user U1 and the terminal device 20B of user U2 via the communication unit 31.

In this example, the control unit 33 of the control device 30 sends an instant message to the terminal device 20A of user U1. This instant message includes the text “We propose a vehicle dispatch”, along with the result of comparison between the transportation vehicle 10A (first time T1-A and first cost C1-A) and the delivery vehicle 10B (second time T2-A and second cost C2-A) generated based on the position information on user U1. Similarly, the control unit 33 of the control device 30 sends an instant message to the terminal device 20B of user U2. This instant message includes the text “We propose a vehicle dispatch”, along with the result of comparison between the transportation vehicle 10A (first time T1-B and first cost C1-B) and the delivery vehicle 10B (second time T2-B and second cost C2-B) generated based on the position information on user U2.

In addition, the control unit 33 of the control device 30 sends an instant message including the text “If you want to dispatch a vehicle, enter “Dispatch a transportation vehicle” or “Dispatch a delivery vehicle”” to both the terminal device 20A of user U1 and the terminal device 20B of user U2.

In step S117, the control unit 26 of the terminal device 20A of user U1 receives the instant message including the result of comparison, sent in step S116, via the communication unit 21. The control unit 26 displays the result of comparison between the travel plan of the transportation vehicle 10A, which transports user U1 from the user position, where user U1 is positioned, to the facility location where the facility is located, and the travel plan of the delivery vehicle 10B that delivers goods provided at the facility from the facility location to the user position. The control unit 26 displays the instant message, which includes the received result of comparison, via the output unit 24.

In this example, the control unit 26 of the terminal device 20A receives the instant message from the control device 30. This instant message includes the text “We propose a vehicle dispatch” along with the result of comparison between the transportation vehicle 10A (first time T1-A and first cost C1-A) and the delivery vehicle 10B (second time T2-A and second cost C2-A). In addition, the control unit 26 receives the instant message including the text “If you want to dispatch a vehicle, enter “Dispatch a transportation vehicle” or “Dispatch a delivery vehicle””. The control unit 26 displays the received instant message, for example, on the display included in the output unit 24.

In step S118, the control unit 26 of the terminal device 20B of user U2 receives the instant message, sent in step S116, via the communication unit 21. The control unit 26 displays the received instant message via the output unit 24.

In this example, the control unit 26 of the terminal device 20B receives the instant message from the control device 30. This instant message includes the text “We propose a vehicle dispatch” along with the result of comparison between the transportation vehicle 10A (first time T1-B and first cost C1-B) and the delivery vehicle 10B (second time T2-B and second cost C2-B). In addition, the control unit 26 receives the instant message including the text “If you want to dispatch a vehicle, enter “Dispatch a transportation vehicle” or “Dispatch a delivery vehicle””. The control unit 26 displays the received instant message, for example, on the display included in the output unit 24.

In step S119, the control unit 26 of the terminal device 20A of user U1 generates an instant message requesting the dispatch of the transportation vehicle 10A or the delivery vehicle 10B. More specifically, the control unit 26 receives an operation for user U1 to input a text via the input unit 25. The control unit 26 generates an instant message including the entered text. The control unit 26 sends the generated instant message to the control device 30 via the communication unit 21.

In this example, user U1 enters the text “Dispatch a transportation vehicle” or “Dispatch a delivery vehicle” to the terminal device 20A. The control unit 26 of the terminal device 20A sends an instant message, which includes the entered text, to the control device 30.

In step S120, as described above in step S102, the control unit 33 of the control device 30 processes the received instant message.

In this example, the control unit 33 of the control device 30 sends an instant message, which includes the text “Dispatch a transportation vehicle” or “Dispatch a delivery vehicle” received from the terminal device 20A of user U1, to the terminal device 20B of user U2. The control unit 33 stores the received instant message in the storage unit 32 as one or more instant messages sent by user U1 after the user receives the instant message that includes the result of comparison.

In step S121, the control unit 33 of the control device 30 determines the necessity to dispatch the transportation vehicle 10A or the delivery vehicle 10B, based on the one or more instant messages sent by user U1 after the user receives the instant message that includes the result of comparison. More specifically, the control unit 33 determines, through natural language processing, whether the text requesting the dispatch of the transportation vehicle 10A or the delivery vehicle 10B is included in the one or more instant messages sent by user U1 after the user receives the instant message that includes the result of comparison. Based on this determination, the control unit 33 determines the necessity to dispatch the transportation vehicle 10A or the delivery vehicle 10B. For example, when the control unit 33 determines that the dispatch of the transportation vehicle 10A is necessary, the control unit 33 dispatches the transportation vehicle 10A based on the generated travel plan of the transportation vehicle 10A. On the other hand, when the control unit 33 determines that the dispatch of the delivery vehicle 10B is necessary, the control unit 33 dispatches the delivery vehicle 10B based on the generated travel plan of the delivery vehicle 10B.

In this example, the control unit 33 of the control device 30 determines whether the text “Dispatch a transportation vehicle” or “Dispatch a delivery vehicle” is included in the instant message received from the terminal device 20A of user U1. When the text “Dispatch a transportation vehicle” is included in the instant message, the control unit 33 determines that the dispatch of the transportation vehicle 10A is necessary. When the text “Dispatch a delivery vehicle” is included in the instant message, the control unit 33 determines that the dispatch of the delivery vehicle 10B is necessary. Instead of the text “Dispatch a transportation vehicle”, another text or an image indicating that transportation is desired may be included in the instant message. In such a case, the control unit 33 may determine that the dispatch of the transportation vehicle 10A is necessary. Instead of the text “Dispatch a delivery vehicle”, another text or an image indicating that delivery is desired may be included in the instant message. In such a case, the control unit 33 may determine that the dispatch of the delivery vehicle 10B is necessary.

In step S122, the control unit 26 of the terminal device 20B of user U2 displays the received instant message.

More specifically, the control unit 26 of the terminal device 20B of user U2 receives the instant message, sent in step S120, via the communication unit 21. The control unit 26 displays the received instant message via the output unit 24.

In this example, the control unit 26 of the terminal device 20B of user U2 receives the instant message, which includes the text “Dispatch a transportation vehicle” or “Dispatch a delivery vehicle”, from the control device 30. The control unit 26 displays the received instant message, for example, on the display included in the output unit 24.

In this example, as the result of comparison of the travel plans, the terminal device 20 displays a part of the travel plan of both the transportation vehicle 10A and the delivery vehicle 10B in comparative form as shown in FIG. 8. However, the result of comparison displayed by the terminal device 20 is not limited to the example shown in FIG. 8. For example, the terminal device 20A may display all of the travel plan of both the transportation vehicle 10A and the delivery vehicle 10B as the result of comparison. The terminal device 20 may also display the difference between the travel plan of the transportation vehicle 10A and the travel plan of the delivery vehicle 10B as the result of comparison. Furthermore, the terminal device 20 may display one of the travel plan of the transportation vehicle 10A and the travel plan of the delivery vehicle 10B as the result of comparison. For example, the terminal device 20 may display only the travel plan of the transportation vehicle 10A or the travel plan of the delivery vehicle 10B whichever is earlier in arriving at the destination or whichever is lower in cost.

When displaying one of the travel plans, the control unit 33 of the control device 30 may send to the terminal device 20 an instant message in step S116 described above that includes, as the result of comparison, the information indicating which travel plan, either the travel plan of the transportation vehicle 10A or the travel plan of the delivery vehicle 10B, is useful for the user.

For example, the control unit 33 of the control device 30 may determine one of the travel plans, either the travel plan of the transportation vehicle 10A or the travel plan of the delivery vehicle 10B whichever is earlier in arriving at the destination or whichever is lower in cost, as the travel plan useful for the user.

The control unit 33 of the control device 30 may determine one of the travel plans, either the travel plan of the transportation vehicle 10A or the travel plan of the delivery vehicle 10B, as the travel plan useful for the user, based on the information indicating the facility or indicating goods provided at the facility both of which are extracted from the instant messages.

The control unit 33 of the control device 30 may determine a deterioration in goods, provided at the facility, that may be caused due to delivery, based on the information indicating the facility. In addition, the control unit 33 of the control device 30 may determine a deterioration in goods that may be caused due to delivery, based on the information indicating the goods provided at the facility. Furthermore, the control unit 33 of the control device 30 may determine a deterioration in goods that may be caused due to delivery, for example, based on the satisfaction evaluation results of a plurality of users to which the goods were delivered.

The control unit 33 of the control device 30 may determine the travel plan useful for the user, either the travel plan of the transportation the vehicle 10A or the travel plan of the delivery vehicle 10B, based on a deterioration in goods that may be caused due to delivery. For example, when goods are easily spilled or broken like ramen or glassware, the control unit 33 determines that the goods are likely to deteriorate due to delivery. In such a case, when an unpaved road or the like is included in the travel route, the control unit 33 determines that the transportation vehicle 10A is useful for the user. Furthermore, when goods are served at high or low temperatures (such as ramen or ice cream), the quality of the goods deteriorate due to a change in temperature and, therefore, the control unit 33 determines that the goods are likely to deteriorate due to delivery. In such a case, when the distance from the user position to the facility location is long, the control unit 33 determines that the transportation vehicle 10A is useful for the user. On the other hand, when goods do not easily deteriorate due to delivery (such as a lunch box), the control unit 33 determines that the goods are less likely to deteriorate due delivery. In such a case, the control unit 33 determines that the delivery vehicle 10B is useful for the user.

As described above, the control device 30 according to this embodiment includes the control unit 33. The control unit 33 generates the result of comparison between the travel plan of the transportation vehicle 10A and the travel plan of the delivery vehicle 10B. The transportation vehicle 10A transports the user from the user position where the user is positioned to the facility location where the facility is located. The delivery vehicle 10B delivers goods provided at the facility from the facility location to the user position. This configuration allows the control device 30 to provide useful information for use when the user determines the necessity to dispatch the vehicle 10. In particular, the result of comparison between the travel plan of the transportation vehicle 10A and the travel plan of the delivery vehicle 10B, provided by the control device 30, makes it easy for the user to select a dispatch of the vehicle 10 suitable for the user himself. Therefore, the control device 30 can improve the convenience of the technique for dispatching the vehicle 10.

In the control device 30 according to this embodiment, the control unit 33 calculates a first time that is a time when the transportation vehicle 10A arrives at the facility location and a second time that is a time when the delivery vehicle 10B arrives at the user position. Using the result of this calculation, the control unit 33 can generate the result of comparison including the result of comparison between the first time and the second time. This configuration allows the control device 30 to provide the result of comparison about the arrival times that is useful when the user determines the dispatch of the vehicle 10.

In the control device 30 according to this embodiment, the control unit 33 calculates a first cost required for transportation by the transportation vehicle 10A and a second cost required for delivery by the delivery vehicle 10B. Using the result of this calculation, the control unit 33 can generate the result of comparison including the result of comparison between the first cost and the second cost. This configuration allows the control device 30 to provide the result of comparison about the cost that is useful when the user determines the dispatch of the vehicle 10.

In the control device 30 according to this embodiment, the control unit 33 can identify the user position based on the position information on the user included in one or more instant messages sent and received by the user. This configuration allows the control device 30 to identify the position of the user based on the content of instant messages sent and received by the user, improving the convenience of the user.

In the control device 30 according to this embodiment, the control unit 33 identifies the facility location based on the information indicating the facility included in one or more instant messages sent and received by the user. This configuration allows the control device 30 to identify the location of the facility in which the user is interested, based on the content of instant messages sent and received by the user, reducing the burden on the user for setting the facility location.

In the control device 30 according to this embodiment, the control unit 33 identifies the facility location based on the information indicating goods provided at the facility included in one or more instant messages sent and received by the user. This configuration allows the control device 30 to identify the location of the facility where the goods in which the user is interested are provided, based on the content of instant messages sent and received by the user, reducing the burden on the user for setting the facility location.

In the control device 30 according to this embodiment, the control unit 33 can control the sending to the user an instant message that includes the result of comparison. This configuration allows the control device 30 to send to the user an instant message that indicates the result of comparison about the dispatch of the vehicle 10 even while the user is sending and receiving instant messages. This means that the user can view the result of comparison without interrupting the sending and receiving of instant messages.

In the control device 30 according to this embodiment, the control unit 33 can determine the necessity to dispatch the transportation vehicle 10A or the delivery vehicle 10B based on one or more instant messages sent by the user after the user receives the instant message including the result of comparison. This configuration allows the control device 30 to dispatch the vehicle 10 by sending an instant message to the user who is sending and receiving instant messages.

The terminal device 20 according to this embodiment includes the control unit 26. The control unit 26 controls the display of the result of comparison between the travel plan of the transportation vehicle 10A and the travel plan of the delivery vehicle 10B. The transportation vehicle 10A transports the user from the user position where the user is positioned to the facility location where the facility is located. The delivery vehicle 10B delivers goods provided at the facility from the facility location to the user position. This configuration allows the terminal device 20 to provide the information that is useful for the user to determine the necessity to dispatch the vehicle 10. In particular, the result of comparison between the travel plan of the transportation vehicle 10A and the travel plan of the delivery vehicle 10B, provided by the terminal device 20, makes it easy for the user to select the dispatch of the vehicle 10 suitable for the user himself. Therefore, the terminal device 20 can improve the convenience of the technique for dispatching the vehicle 10.

In the terminal device 20 according to this embodiment, the control unit 26 can control the display of an instant message that includes the result of comparison. This configuration allows the terminal device 20 to provide an instant message, which indicates the result of comparison about the dispatch of the vehicle 10, to the user who is sending and receiving instant messages. This means that the user can browse the result of comparison without interrupting the sending and receiving of instant messages.

In the terminal device 20 according to this embodiment, the control unit 26 can control the sending of an instant message that includes the position information on the user. This configuration allows the terminal device 20 to cause a user, who is sending and receiving instant messages, to send the position information on the user, necessary for generating the travel plan of the vehicle 10, as an instant message.

In the terminal device 20 according to this embodiment, the control unit 26 can control the measurement of the position of the terminal device 20 itself and then control the sending of an instant message that includes, as the user position information, the measured position of the terminal device 20. This configuration allows the terminal device 20 to send the position information on the user, necessary for generating the travel plan of the vehicle 10, as an instant message, improving the convenience of the user.

Although the present disclosure has been described with reference to the drawings and examples, it should be noted that those skilled in the art can easily make various changes and modifications based on the present disclosure. Therefore, it is to be noted that these changes and modifications are within the scope of the present disclosure.

For example, it is possible to relocate the functions included in each unit or each step in such a way that they are not logically contradictory, and it is possible to combine a plurality of units or steps into one or to divide them.

For example, all or a part of the functions or processing described in the embodiment above as the functions or processing of the terminal device 20 or the control device 30 may be implemented as the functions or processing of a general-purpose information processing device such as a smartphone or a personal computer. More specifically, a program describing the processing for implementing the functions of the terminal device 20 or the control device 30 according to this embodiment may be stored in the memory of an information processing device so that the processor of the information processing device can read the program for execution. Therefore, the disclosure according to this embodiment may also be implemented as a program executable by the processor. For example, the vehicle 10 may function as the terminal device 20 or the control device 30 described above. In such a case, the vehicle 10 may be configured to include an information processing device having the configuration and function that are described above as the configuration and function of the terminal device 20 or the control device 30.

Furthermore, in the embodiment described above, the control device 30 may be configured to perform a part or all of the operations and processing performed by the terminal device 20. Similarly, the terminal device 20 may be configured to perform a part or all of the operations and processing performed by the control device 30. For example, the information processing system 1 may not include the control device 30. In such a case, the terminal device 20 may be configured to perform all of the operations and processing performed by the terminal device 20 and the control device 30 in the embodiment described above.

Furthermore, in the embodiment described above, the control unit 33 of the control device 30 generates the result of comparison between the travel plan of the transportation vehicle 10A and the travel plan of the delivery vehicle 10B based on the information extracted from one or more instant messages sent and received among a plurality of users. However, the control unit 33 of the control device 30 may compare the travel plan of the transportation vehicle 10A and the travel plan of delivery vehicle 10B based on the information obtained from the terminal device 20 of the user that is the information in addition to, or instead of, instant messages. For example, the control unit 33 of the control device 30 may compare the travel plan of the transportation vehicle 10A and the travel plan of the delivery vehicle 10B based on the information entered by the user via a web page displayed on the terminal device 20. For example, when the user selects desired goods on a web page or the like displayed on the terminal device 20, the control unit 33 of the control device 30 may compare the travel plan of the transportation vehicle 10A and the travel plan of the delivery vehicle 10B based on the selected goods.

What is claimed is:

1. A control device comprising a control unit configured to generate a result of comparison between a travel plan of a transportation vehicle and a travel plan of a delivery vehicle, the transportation vehicle being a vehicle that transports a user from a user position where the user is positioned to a facility location where a facility is located, the delivery vehicle being a vehicle that delivers goods provided at the facility from the facility location to the user position.

2. The control device according to claim 1, wherein:
the control unit is configured to calculate a first time and a second time, the first time being a time when the transportation vehicle arrives at the facility location, the second time being a time when the delivery vehicle arrives at the user position; and
the control unit is configured to generate the result of comparison including a result of comparison between the first time and the second time.

3. The control device according to claim 1, wherein:
the control unit is configured to calculate a first cost and a second cost, the first cost being a cost required for transportation by the transportation vehicle, the second cost being a cost required for delivery by the delivery vehicle; and
the control unit is configured to generate the result of comparison including a result of comparison between the first cost and the second cost.

4. The control device according to claim 1, wherein the control unit is configured to identify the user position based on user position information included in one or more instant messages sent and received by the user.

5. The control device according to claim 1, wherein the control unit is configured to identify the facility location based on facility information included in one or more instant messages sent and received by the user.

6. The control device according to claim 1, wherein the control unit is configured to identify the facility location based on information indicating the goods provided at the facility included in one or more instant messages sent and received by the user.

7. The control device according to claim 1, wherein the control unit is configured to control sending of an instant message including the result of comparison to the user.

8. The control device according to claim 7, wherein the control unit is configured to determine a necessity to dispatch the transportation vehicle or the delivery vehicle based on one or more instant messages sent by the user after the user receives the instant message including the result of comparison.

9. A program that causes an information processing device to function as a control device comprising a control unit configured to generate a result of comparison between a travel plan of a transportation vehicle and a travel plan of a delivery vehicle, the transportation vehicle being a vehicle that transports a user from a user position where the user is positioned to a facility location where a facility is located, the delivery vehicle being a vehicle that delivers goods provided at the facility from the facility location to the user position.

10. The program according to claim 9, wherein:
the control unit is configured to calculate a first time and a second time, the first time being a time when the transportation vehicle arrives at the facility location, the second time being a time when the delivery vehicle arrives at the user position; and
the control unit is configured to generate the result of comparison including a result of comparison between the first time and the second time.

11. The program according to claim 9, wherein:
the control unit is configured to calculate a first cost and a second cost, the first cost being a cost required for transportation by the transportation vehicle, the second cost being a cost required for delivery by the delivery vehicle; and
the control unit is configured to generate the result of comparison including a result of comparison between the first cost and the second cost.

12. The program according to claim 9, wherein the control unit is configured to identify the user position based on user position information included in one or more instant messages sent and received by the user.

13. The program according to claim 9, wherein the control unit is configured to identify the facility location based on facility information included in one or more instant messages sent and received by the user.

14. The program according to claim 9, wherein the control unit is configured to identify the facility location based on information indicating the goods provided at the facility included in one or more instant messages sent and received by the user.

15. The program according to claim 9, wherein the control unit is configured to control sending of an instant message including the result of comparison to the user.

16. The program according to claim 15, wherein the control unit is configured to determine a necessity to dispatch the transportation vehicle or the delivery vehicle based on one or more instant messages sent by the user after the user receives the instant message including the result of comparison.

17. A program that causes an information processing device to function as a terminal device comprising a control unit configured to control a display of a result of comparison between a travel plan of a transportation vehicle and a travel plan of a delivery vehicle, the transportation vehicle being a vehicle that transports a user from a user position where the user is positioned to a facility location where a facility is located, the delivery vehicle being a vehicle that delivers goods provided at the facility from the facility location to the user position.

18. The program according to claim 17, wherein the control unit is configured to control a display of an instant message including the result of comparison.

19. The program according to claim 17, wherein the control unit is configured to control sending of an instant message including position information on the user.

20. The program according to claim 19, wherein the control unit is configured to measure a position of the terminal device itself and configured to control sending of an instant message including the measured position of the terminal device itself as the position information on the user.
